(19) United States
(12) Patent Application Publication
(10) Pub. No.: US 2003/0009922 A1
(43) Pub. Date: Jan. 16, 2003

(54) 3D moving picture

(76) Inventor: Peter Liu, Cerritos, CA (US)

Correspondence Address: Joe Nieh, Suite 411, 17800 Castleton Street, Industry, CA, 91748, US

(21) Appl. No.: 09/902,387

(22) Filed: Jul. 10, 2001

(51) Int. Cl. G09G 5/00; G09F 13/00; G09F 19/00

(52) U.S. Cl. 40/434; 40/435

(57) ABSTRACT

The present invention comprises of an enclosure with an opening wherein a 3-dimentional translucent picture is attached to said opening. Multiple pieces of polarized film are attached behind various portions of the 3-dimentional translucent picture. The enclosure contains a light source, a polarized film, and means for moving said polarized film within the enclosure. The 3-dimentional translucent picture will appear to have motion when the polarized film is moved relative to the pieces of polarized film attached behind the 3-dimentional translucent picture.

### BACKGROUND

1. Field of Invention

The present invention is a visually 3-dimentional illuminated picture that appears to have motion within it.

2. Description of Related Art

A light box is generally used for examining film negatives and x-rays films. The light box generally has a light source inside the enclosure. The light source may be an incandescent light bulb or a fluorescent light tube. The enclosure generally has one of its surfaces being transparent or translucent to permit light from the enclosed light source to pass through it. The film negative or the x-ray film is placed on the transparent or translucent surface of the enclosure for viewing. The light from the light source enclosed in the enclosure will pass through the transparent or translucent surface and the film negative or x-ray film on it to permit viewing of the same.

A 2-dimentional translucent static picture can be made to appear to have movement within it by attaching pieces of polarized films behind various portions of the 2-dimentional translucent static picture and illuminating it with a light source shining through another moving or rotating piece of polarized film. The moving or rotating piece of polarized film along with the pieces of polarized films behind the translucent picture will alter the light wave and cause the various portions of the 2-dimentional translucent static picture to appear to have movement within it.

A 2-dimentional static picture can also be made to appear 3-dimentional by printing different portions of the 2-dimentional static picture on different layers of transparent films and bonding them together to form a picture that appears to have depth. This visual perception of depth gives the 2-dimentional static picture the appearance that it is 3-dimentional.

### SUMMARY OF THE INVENTION

The present invention comprises of an enclosure with an opening wherein said enclosure contains a light source, a polarized film, means for moving said polarized film within the enclosure, and a 3-dimentional translucent picture attached to said opening in the enclosure with pieces of polarized films attached behind various portions of the 3-dimentional translucent picture. The 3-dimentional translucent picture will appear to have motion when the polarized film is moved relative to the pieces of polarized film attached behind the 3-dimentional translucent picture.

### BRIEF DESCRIPTION OF THE DRAWINGS

FIG. 1 shows the side view of the preferred embodiment of the present invention.

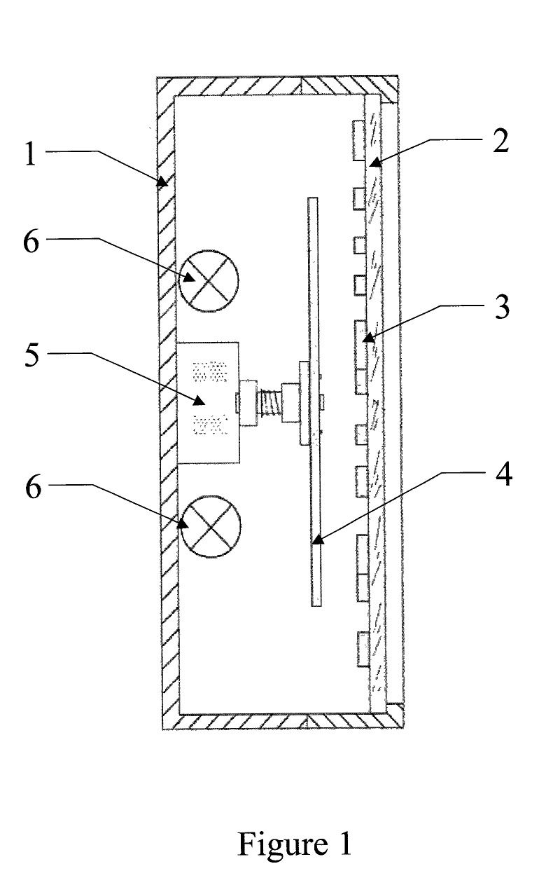

### DETAILED DESCRIPTION OF THE PREFERRED EMBODIMENT

The preferred embodiment of the present invention comprises of an enclosure 1 with an opening. A 3-dimentional translucent picture 2 is attached to the opening of the enclosure 1 such that it closed the opening to the enclosure 1. Multiple pieces of polarized film 3 are attached to the side of the 3-dimentional translucent picture 2 that faces the interior of the enclosure 1. A piece of polarized film 4 is attached to an electric motor 5 wherein said electric motor 5 will cause rotational movement of the polarized film 4 within said enclosure 1. A light source 6 is placed behind the polarized film 4 whereby the light emitted from said light source 6 will shine through the polarized film 4, through the multiple pieces of polarized film 3, and also through the 3-dimentional translucent picture 2.

When electricity is supplied to the electric motor 5 and the light source 6, the electric motor 5 will rotate causing the polarized film 4 to rotate within the enclosure 1 and the light source 6 will emit light. The light emitted from the light source 6 will shine through the rotating polarized film 4, through the multiple pieces of polarized film 3, and also through the 3-dimentional translucent picture 2 attached to the opening of the enclosure 1. The alternating of the light wave by the polarizing films will cause various portions of the 3-dimentional translucent picture 2 to appear to have movement when the 3-dimentional translucent picture 2 is viewed through the opening of the enclosure 1.

Another embodiment of the present invention may use means other than an electric motor 5 to caused movement of the polarizing film 4 relative to the multiple pieces of polarized film 3.

Another embodiment of the present invention may utilize incandescent light bulb as the light source 6 for illumination.

Yet another embodiment of the present invention may utilize fluorescent light as the light source 6 for illumination.

What is claimed is:

1. A 3D Moving Picture comprising:
an enclosure with an opening;
a 3-dimentional translucent picture attached to the opening of the enclosure with multiple pieces of polarized film attached to the 3-dimentional translucent picture surface facing the interior of the enclosure;
a polarizing film;
means to cause movement of the polarizing film attached to said means;
a light source located on the side of the polarizing film opposite the 3-dimentional translucent picture such that the light emitted from said light source will shine through the polarizing film, the multiple pieces of polarized film attached to the 3-dimentional translucent picture, and through the 3-dimentional translucent picture;
wherein various portions of the 3-dimentional translucent picture will appear to have movement.

2. A 3D Moving Picture according to claim 1, wherein said means to cause movement of the polarizing film is an electric motor.

3. A 3D Moving Picture according to claim 1, wherein said light source is an incandescent light bulb.

4. A 3D Moving Picture according to claim 1, wherein said light source is a fluorescent light source.

5. A 3D Moving Picture according to claim 1, wherein said means to cause movement of the polarizing film is attached to the interior of the enclosure.

6. A 3D Moving Picture according to claim 1, wherein said light source is attached to the interior of the enclosure.
